(19) United States
(12) Patent Application Publication
(10) Pub. No.: US 2005/0027649 A1
(43) Pub. Date: Feb. 3, 2005

(54) Event typer

(76) Inventor: Richard Cech, New York, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/789,583

(22) Filed: Feb. 27, 2004

Related U.S. Application Data
(60) Provisional application No. 60/450,800, filed on Feb. 28, 2003.
(60) Provisional application No. 60/450,809, filed on Feb. 27, 2003.

(51) Int. Cl. A63F 9/24; A63F 13/00; G06F 17/00; G06F 19/00; G06F 17/60

(52) U.S. Cl. 705/38

(57) ABSTRACT

A method of categorizing risk events is presented. A minimal list of predetermined questions is presented to a user seeking to “type” a risk event. The questions are probative regarding the event, but non-intuitive compared to traditional questions that elicit an event narrative. The answers to the questions define “attributes of the event”. The method maps the answers to lists of possible event types. Each successive answer generates another list of possible event types. The lists of possible event types are then combined to yield one or more common event types for the occurrence of a risk event being typed. In the preferred embodiment, five questions have been found to be sufficient to type most, if not all, event occurrences. The result is one or more event types, preferably one event type that is recorded for each risk event occurrence.

### CROSS REFERENCE TO RELATED APPLICATIONS

This application claims the benefit of U.S. Provisional Applications Ser. No. 60/450,800 filed Feb. 28, 2003 and Ser. No. 60/450,809 filed Feb. 27, 2003. The 60/450,800 and 60/450,809 applications are incorporated by reference herein.

### FIELD OF THE INVENTION

This invention relates to methods of categorizing risk, and more particularly to a method of typing risk events based on predefined factors.

### BACKGROUND OF THE INVENTION

Risk events, such as operational losses, occur routinely in business. Risk events are occurrences that have actual or potential financial impact on an organization, typically impact in excess of a defined threshold. Risk events that have adverse consequences to an organization are of particular importance as they can cause economic loss and loss of reputation to the organization. Examples of these types of risk events are theft (by organization outsiders or employees), employee errors, fires that destroy records and/or capital equipment, terrorism and natural disasters.

Businesses such as financial organizations track operational losses caused by occurrences of risk events, and analyze and categorize them. Managers reporting such losses attempt to accurately define event types. Event typing can be useful for reporting the event to the appropriate part of the organization, for storing the event categorization for business risk event statistics recording, and for the prediction of future risk events.

Risk event reporting is of particular importance to banks. Banks allocate reserves as required by international convention as contingencies against various types of potential risk events. The amount of these allocations is based in part on past occurrences of risk events. Event typing of past risk event occurrences can also affect insurance policies related to risks.

It is important that standardized risk event reporting be implemented. In part, this is because some reserves spread risk among many organizations. Standardized risk event typing can also help to foster an environment that will allow for industry wide analysis of risk events. Industry wide standard risk event reporting would likely lead to more meaningful and successful plans to lower the occurrence of undesirable risk events.

The Basel Accord is an international agreement related to international banking practices. Standardization of risk event reporting is one area of interest of the Basel working group. The Institute of Finance Industry group (IIF) of the Basel Internal Technical Working Group (ITWG) has adopted industry standards for the assessment of risk events.

The problem is that reporters of risk events within organizations, and between different organizations, report event types in non-standard ways, which makes later organization wide or industry wide analysis more difficult. What is needed is a standard way for all banks to report risk event types, preferably using industry standard categories.

### SUMMARY OF THE INVENTION

A new method of categorizing risk events is presented. A minimal list of predetermined questions is presented to a user seeking to “type” a risk event. The questions are probative regarding the event, but non-intuitive compared to traditional questions that elicit a narrative of an event occurrence. The answers to the questions define “attributes” of the event occurrence. The method maps the answer to each question to a list of possible event types. Each successive answer generates another list of possible event types. The lists of possible event types are then combined to yield one or more common event types for the risk event occurrence being typed. In the preferred embodiment, five questions have been found to be sufficient to type most, if not all, event occurrences. The result is one or more event types, preferably one event type that is recorded for each risk event occurrence. Based on the event type from one or more event typings, an organization can take actions including risk event minimization, compliance with risk event reporting requirements, and establishing appropriate reserves to protect against future possible risk events.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 shows suitable hardware environments for performing the inventive method;

FIG. 2 shows a software environment suitable for event typing;

FIG. 3 shows a Venn diagram illustrating event type selection;

FIG. 4 shows the steps to perform event typing in accordance with one embodiment of the invention;

FIG. 5 shows a graphical user interface suitable for event typing; and

FIGS. 6A-6G show tables of the event types as mapped to answers to questions 1-5.

It is to be understood that the drawings are for the purpose of illustrating the concepts of the invention and are not to scale. It is also understood that all application code, other framework code, database programs, and data that can be used to implement the inventive method reside on computer readable media and run on one or more computer systems including standard computer components and operating systems as known in the art. Furthermore the invention can be implemented on a standalone computer, a client computer communicating with a server computer, or the software modules necessary to implement the inventive method can be distributed among computers on an intranet or on the Internet. The inventive method can be performed by software written in programming languages as known in the art, including, but not limited to, object oriented languages such as C++, Java or J2EE.

### DETAILED DESCRIPTION

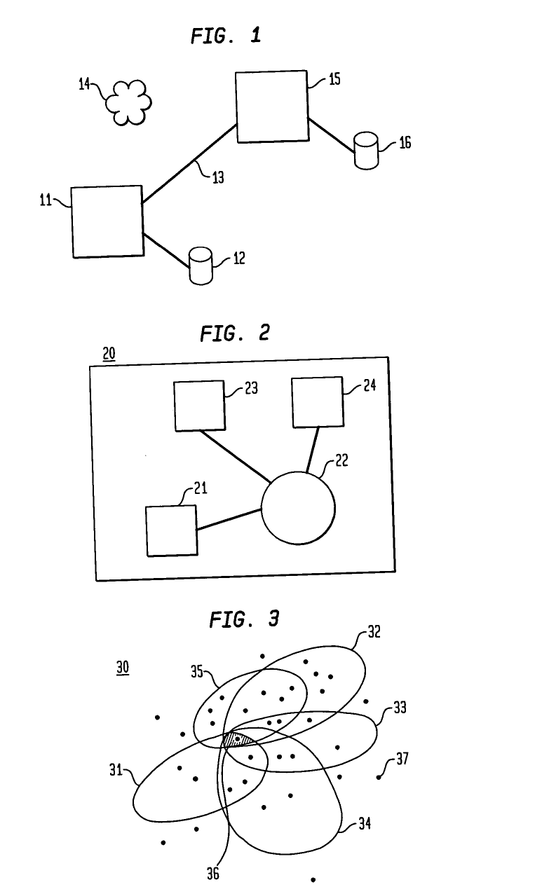

FIG. 1 shows a hardware configuration suitable for use as an event typer. Standalone computer 11 is associated with non-volatile memory 12. Computer 11 can also be connected to network 13 via an intranet or the Internet 14. Network 13 can be wired or wireless. Another computer 15 can be a server on the network 13 and/or the Internet 14. Computer 15 is associated with non-volatile memory 16, such as a hard-drive. The event typer can wholly reside on computer 11 with all of the event attributes saved to memory 12 and the event typer program residing in memory 12. Or, some of all of the event data such as event attributes may be stored in a remote memory, such as memory 16. In another embodiment, computer 11 can merely act as a terminal, with the event typer program running remotely on one or more computers connected to the network (not shown) and event data can be saved to one or more memory storage areas on the network (not shown).

The program code to perform the event typer function can be a standalone program communicating only with its own local memory for storing and retrieving event data. FIG. 2 shows a typical embodiment where the event typer can be a module, or subprogram 21 of an organization's larger risk management computer system 20. In this configuration, main program 22 can call functions in one or more sub-modules as illustrated by modules 23 and 24 (providing different functions than event typer). The event typer can also be configured as a module in a national or international reporting system program.

The inventors realized that very specific questions about a risk event can be used to create an attribute model of an event that can achieve rapid and standardized event typing. The answers to the questions define predetermined characteristics or “attributes” of a risk event occurrence. These questions are different than those that are typically used to bring out the entire narrative of a risk event.

Risk events are typically adverse occurrences that have a negative financial, or potential negative financial impact on an organization. Examples of risk events that can affect a financial organization are: failure to exercise an expiring option, employee disputes over compensation including severance packages, embezzlement of funds, natural disasters including related power losses, failure to comply with banking regulations including resultant fines, loss of funds do to identity theft, unauthorized trading activities including improper trades made for personal gain, money laundering including fines as a consequences of failure to detect it, theft of trade secrets from a competitor, theft of money from ATM machines by employees, failure to state material facts in offering materials for financial instruments, violations of environmental laws including resulting fines, and employee misconduct including diversity and discrimination issues. These are but a few examples of risk events. Some organizations may choose to type and report risk events above some threshold level of impact to the organization, for example, those occurrences of risk events that can result in losses of over $20,000.

An important aspect of the inventive event typer is that the attributes (the answers to the questions) are not event types. They are rather key characteristics, that when taken as a whole, can be important to identifying a risk event type. Another important aspect of the invention is the formulation of the questions. The inventors realized that questions related to specific attributes of an event can uniquely define the event without the need for a typical full descriptive narrative which must then be analyzed by an expert in risk event typing.

The preferred embodiment of the event typer uses five questions to arrive at five answers regarding “attributes” of the risk event. The five specific questions of the preferred embodiment are merely illustrative of questions useful to illicit a minimal set of information needed to arrive at a small set of identifying event types. To the best of the inventor's knowledge, the five questions of the preferred embodiment are an example of an optimized set of questions that can be used to identify industry standard event types.

The answer to each question can be mapped to a list of possible event types for that answer. FIG. 3 shows the mapped set of event types as a Venn diagram. Here ellipse 31 represents the list of possible event types 37 generated by mapping the answer to question 1. Similarly, 32 represents the mapped list from answer 2, 33 represents the mapped list from answer 3, 34 represents the mapped list from answer 4, and 35 represents the mapped list from answer 5. It can then be seen that hatched intersection area 36 represents one or more event types 37 of the event being typed. Thus, the functional result of an event type can be arrived at by finding the common event type(s) that appear in the mapped lists of event types. In the preferred embodiment, the combination of attribute choices and the corresponding mapped lists of possible event types, almost always results in only one common event type.

The attributes associated with each risk event can be conveniently recorded to a computer media for long term or permanent storage. This is particularly useful since events can then be “re-typed” en mass at a later time should the standard question set or typing conventions change.

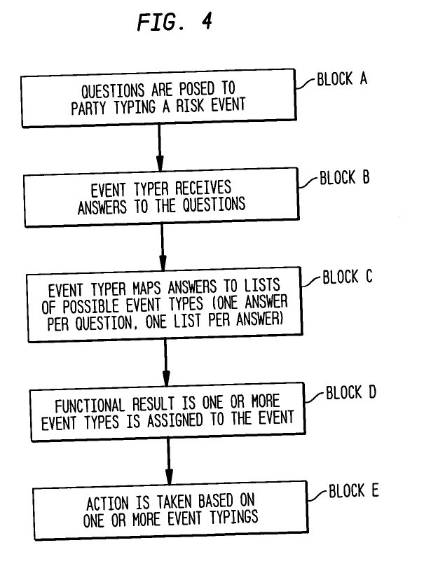

FIG. 4 shows the method steps of the inventive process. First questions are posed to a party with a need to type a risk event (Block A). The event typer receives answers for identifying the nature of the initiator of the event, any benefit to the initiator, the impact caused by the event, the nature of the impact, and the initiator's role in the event (Block B). The answer to each question (the attribute) is then mapped to a list of possible event types that correlate to the attribute (Block C). Next, the lists are compared to derive only those event types 37 that are common to all lists (Block D) as illustrated by intersection 36 of Venn diagram 30 of FIG. 3. And finally, one or more actions are taken based on the resultant event type, such as, but not limited to, reporting the event, collating statistics of various event types, planning strategies to reduce the number of adverse events, or planning event contingency reserve amounts (Block E).

Alternatively, after each successive question, the resultant list of possible event types for that question can be compared with the list resulting from the previous question and reduced to the event types in common between the two questions. Only the remaining common answers need then be compared to the possible event types associated with the next question. Using the latter method, the results are the same as those arrived at when all event lists are compared for common elements only after answering all questions.

In one embodiment, the questions and their corresponding answers are independent of the other questions. After the answers to each question are mapped to lists of event types (each list corresponding to one answer to each question), the resultant event is determined by finding the event types that are common to all mappings. Preferably only one event type results from the elimination process. In a second embodiment, there can be additional logic recognizing that choices to previous questions can in some cases limit the field of possible answers to successive questions. Disallowed answers to successive questions can be disabled or removed. For example, some of the list of possible answers can be “grayed out” such that they are still visible to the user, but inactive and not available for selection. Or, the logic could cause the list of possible answers to successive questions to become truncated depending on one or more previous answers or combinations of previous answers.

Each question prompts the user for an answer, or attribute, of the event. For each question only one possible answer may be selected. Once selected, each answer can be mapped to a list of event types. The mapping associates the chosen answer (or attribute) with standardized events correlating to that answer. The lists of event types that correlate to each answer can be pre-determined by experts in the field of risk management.

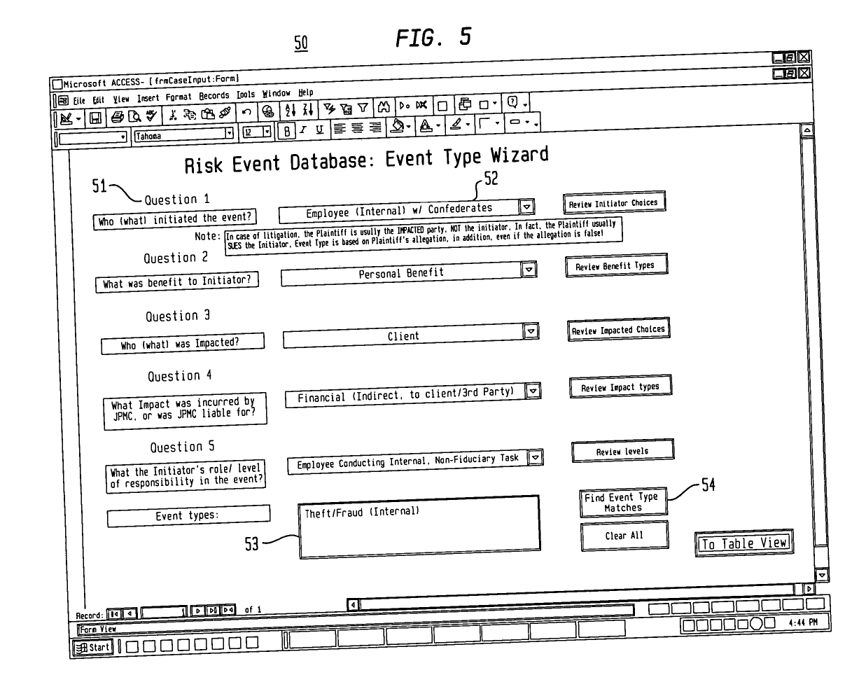

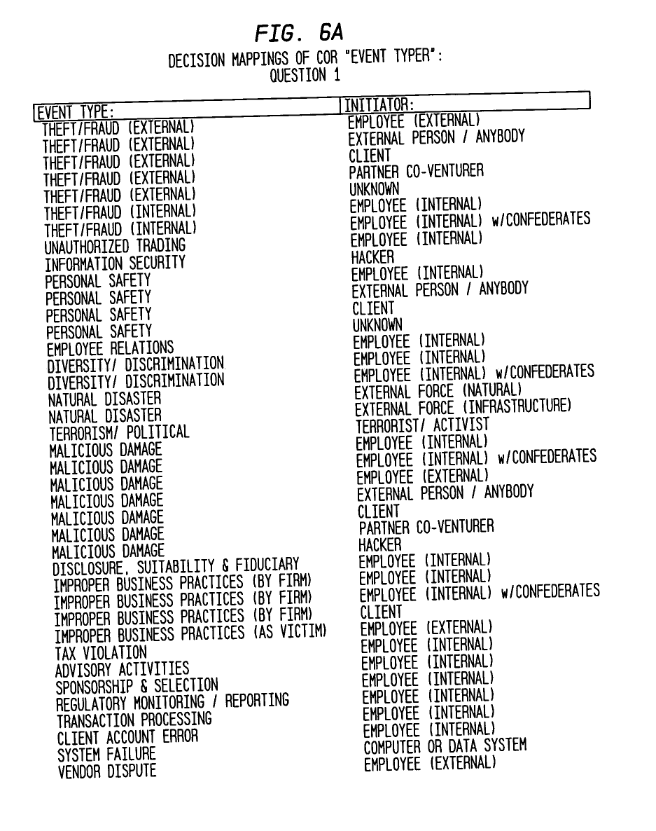

FIG. 5 shows one embodiment of a user interface 50 according to the invention. The questions are displayed, for example, as question 1 51. Pull down menus, as for example the list of choices 52 for the answer to question 1 (not shown pulled down with the choices showing). In this embodiment, after answering five questions, the user selects the screen button “Find Event Type Matches” 54 to find the common event type from the mapped lists of possible event types corresponding to the answer chosen for each question. The common event is then displayed in results window 53.

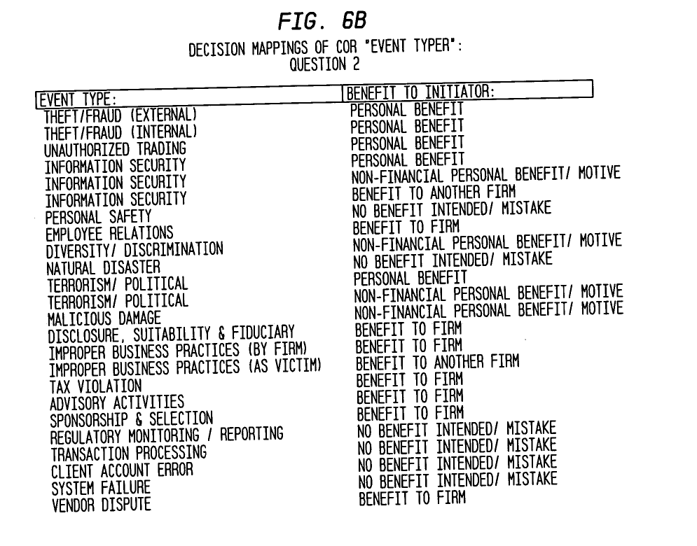

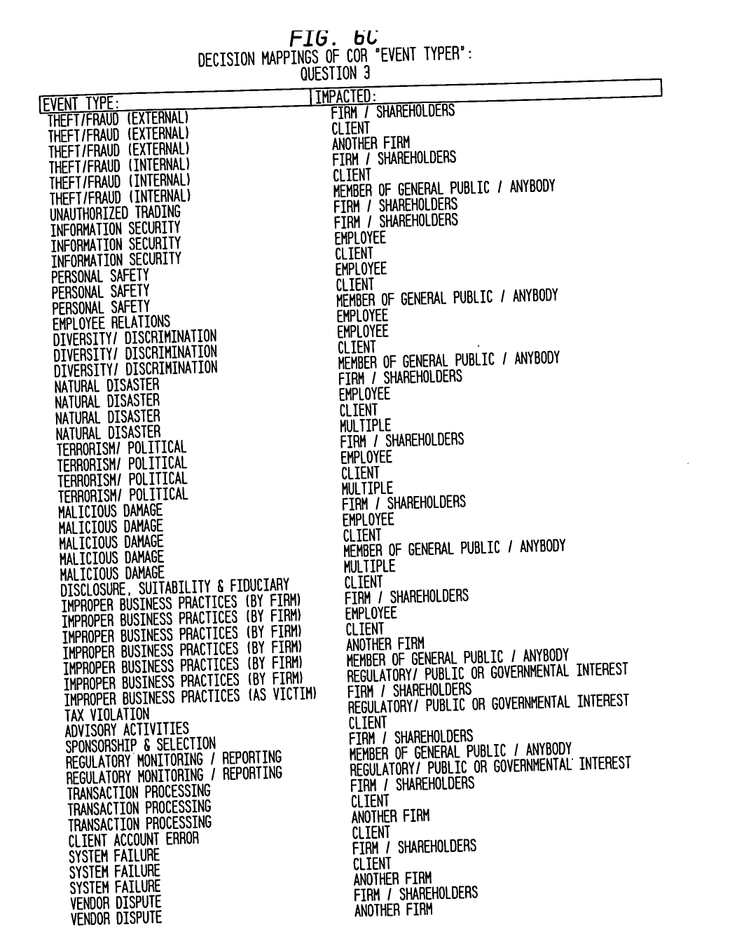

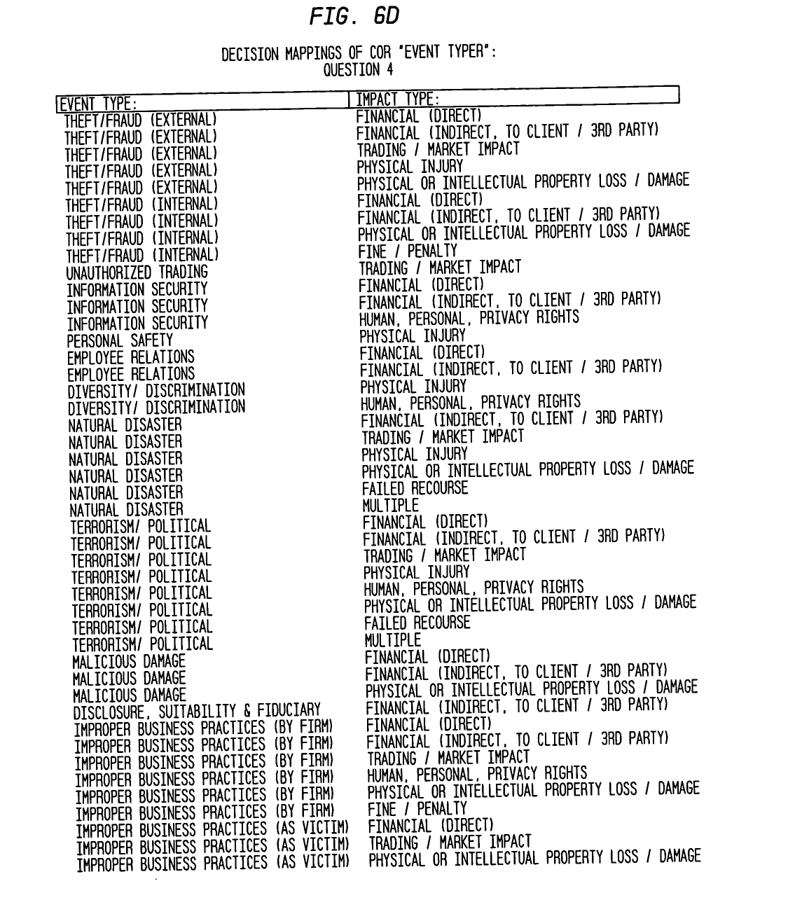

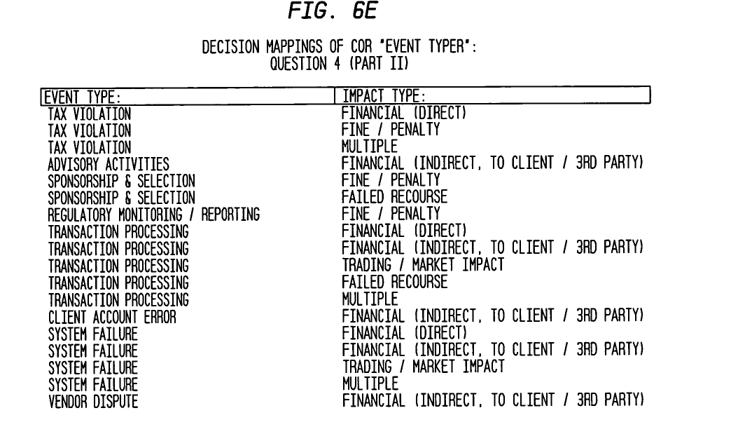

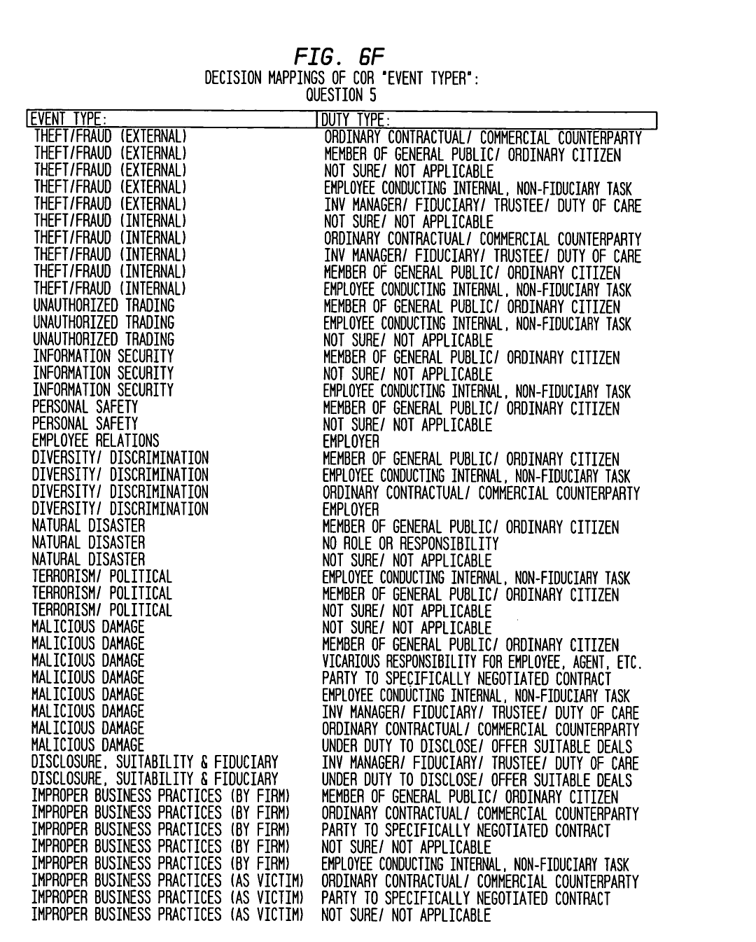

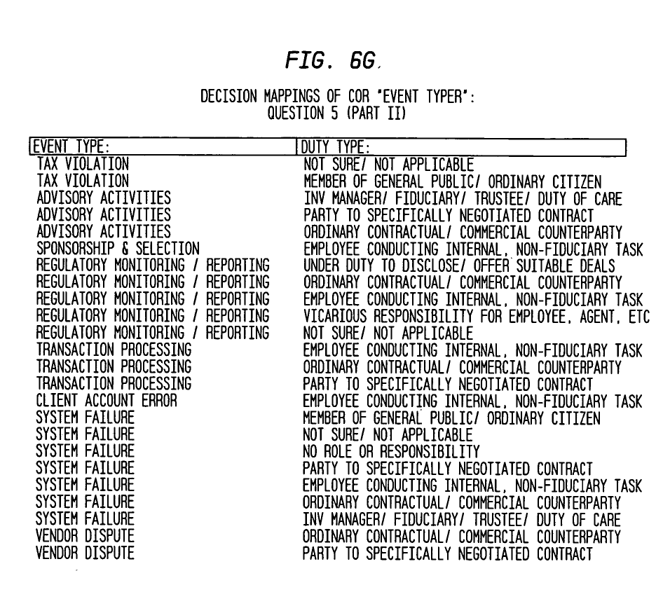

FIGS. 6A-6G show the mappings from answers 1-5 to lists of event types according to the preferred embodiment. Here the event typer is optionally referred to in one embodiment as the corporate operational risk (COR) event typer. For each question, the party seeking to type an event is permitted to choose only one answer. For each answer chosen, FIGS. 6A-6G show the mapping to a list of event types that correspond to the answer for a given question. The order in which the questions are asked and answered is unimportant. At the completion of the questions, the resultant event type or types are those events that are common to all of the mappings. In other words for an event type to be the functional result as the standardized event type for the characterization of a particular risk event, that type must have appeared in all of the mappings from the answers to the five questions.

The inventors discovered that five questions can be sufficient to yield the correct standardized event types for all risk events that have been considered to date. The five questions of the preferred embodiment provide answers that become the attributes of the event. The five questions of the preferred embodiment are: 1) Who initiated the risk event? 2) What was the benefit to the initiator? 3) Who or what was impacted by the event? 4) What was the nature or the impact? 5) What was the initiator's role or duty?

### THE FIVE QUESTIONS WITH ANSWERS OF THE PREFERRED EMBODIMENT

Question 1: Who (What) Initiated the Event?

Answers (choices): Employee (internal); Employee (Internal) with Confederates;
Employee (external); Client; Member of General Public (“External Person”)/Anybody;
Computer or Data System (while operated correctly); Hacker; Terrorist/Activist;
Partner, Co-Venturer; External Force (Natural); External Force (Infrastructure); or Don't Know.
   Question 2: What was Benefit to Initiator? (What was Initiator's action directed to achieve?);
Answers (choices): Personal Benefit; Non-Financial Personal Benefit/Motive (Including political benefit, personal desire to inflict malicious damage or deprivation of others' personal rights, etc.); Benefit to Firm (To get or maintain business, improve the terms of a transaction, avoid competition, etc., even if initiator moved by hope or larger bonus, etc.); Benefit to Another Firm; No Benefit Intended/Mistake; or Don't Know.
   Question 3: Who (what) was Impacted?
Answers (choices): Firm/Shareholders; Employee; Client; Another Firm; Member of General Public/Anybody; Regulatory/Public or Governmental Interest; Multiple; or Don't Know.
   Question 4: What was Nature of Impact? (select the most specific that applies)
Answers (choices): Financial (direct); Financial (indirect, to client/3rd Party); Trading/Market Impact; Physical Injury; Human, Personal, Privacy Rights; Physical or Intellectual Property Loss/Damage; Fine/Penalty; Failed Recourse; Multiple; or Don't Know.
   Question 5: What was the Initiator's role/level of responsibility/legal duty in the event? (select the most specific that applies) Answers (choices): Member of General Public/Ordinary Citizen; Ordinary Contractual/Commercial Counterparty; Employee Conducting Internal, Non-Fiduciary Task;
Employer; Party to Specifically Negotiated Contract; Under Duty to Disclose/Offer Suitable Deals; Investment Manager/Fiduciary/Trustee/Duty of Care; Vicarious Responsibility for employee, agent, etc; No Role or Responsibility; or Don't Know.

### EXAMPLES

The following 14 examples illustrate answers to the 5 questions regarding exemplary risk events and the event types selected for those scenarios by one embodiment of the event typer. It is to be understood that these scenarios are not intended to limit the nature of risk event scenarios that can be typed by the event typer, but are merely illustrative of the typing process.

For the first example, the mapping process is shown in detail. The answers to the five questions are mapped to possible event types using the mapping tables of FIG. 6. Then the common event types of the five mapped event type lists are found to yield one or more (preferably one) standardized event type(s) suitable to describe that particular occurrence of a risk event. The same principle of selection applies to the remainder of the examples and whilst not shown, can be conveniently derived from the FIG. 6 tables as is done in the first two examples.

### Example 1

Although notified in advance of the need to exercise an expiring option, the client representative became distracted and failed to make the call. The client refused to recognize the exercise when it was finally made several hours late.

Question 1: Who (What) Initiated the Event?

=>Answer (A1): Employee (Internal)
   A1 mapping to possible event types: Theft/Fraud (internal); Unauthorized Trading; Personal Safety; Employee Relations; Diversity/Discrimination; Malicious Damage; Disclosure, Suitability & Fiduciary; Improper Business Practices (by firm); Tax Violation; Advisory Activities; Sponsorship & Selection; Regulatory Monitoring/Reporting; Transaction Processing; and Client Account Error.

After only answering one question, the list of possible event types is as listed above, and cannot yet be further limited.

Question 2: What was Benefit to Initiator? (What was Initiator's action directed to achieve?)

=>Answer (A2): No Benefit Intended/Mistake A2 mapping to possible event types: Personal Safety; Natural Disaster; Regulatory Monitoring/Reporting; Transaction Processing; Client Account Error; and System Failure.

After answering the second question, a number of proffered event types that resulted from the A1 mapping can now be eliminated as possible event types for this risk event occurrence: A1 mapping to possible event types reduced by the A2 mapping (all answers not shown in A2 are eliminated): Personal Safety, Regulatory Monitoring/Reporting, Transaction Processing, Client Account Error.

Question 3: Who (what) was Impacted?

=>Answer (A3): Firm/Shareholders

According to FIG. 5C, A3maps to possible event types: Theft/Fraud (external); Theft/Fraud (internal); Unauthorized Trading; Information Security; Natural Disaster; Terrorism/Political; Malicious Damage; Improper Business Practices (by firm); Improper Business Practices (as victim); Sponsorship & Selection; Transaction Processing; System failure; and Vendor Dispute.

While the comparisons and reductions can be done in various ways as will be apparent to those skilled in the art, for illustrative purposes, the elimination process can progress by continuing to eliminate possible event types from the original (now reduced) A1 list: Transaction Processing.

Here it can be seen that after answering only three of the five questions, the proper event type has been selected. In one embodiment of the invention, the comparison process is not done until after all five questions have been answered. In another embodiment, the user can be informed of the proper event type as soon as only one event type has been identified and can be relieved of answering the remainder of the questions. Of course there may situations yielding no event type (null set) after all of the questions are answered, and this situation too, can be informative. A null answer may mean there is a yet undefined risk event, or it can mean that the event presented no risk at all to the entity typing its own risks.

It should also be noted, that an important advantage of attribute models is that the attributes for each risk event can be stored away indefinitely. This can be particularly advantageous if the definitions of standardized event types change. In the case of such a change, all of the prior events, along with their attributes can be run through a program (a new set of rules or mappings) to change the events according to the new rules. It can thus be seen that had all of the questions in this example not been answered, even where unnecessary under the prevailing model, later re-classification of prior events might be impossible.

As event types have been narrowed to one at question 3, it might be unnecessary to continue with this example, but as just discussed, it can still be useful to assign all five attributes to a given risk event. Therefore we continue the example 1 illustration with Question 4:

Question 4: What was Nature of Impact? (select the most specific that applies)

=>Answer (A4): Financial (direct)

The event types mapped to A4are: Theft/Fraud (external); Theft/Fraud (internal); Information Security; Employee Relations; Terrorism/Political; Malicious Damage; Improper Business Practices (by firm); Improper Business Practices (as victim); Tax Violation; Transaction Processing; and System Failure.

It can be seen that Transaction Processing remains as the single selected event type for this risk event following question 4.

Question 5: What the Initiator's role/level of responsibility/legal duty in the event? (select the most specific that applies)

=>Answer (A5): Employee Conducting Internal, Non-Fiduciary task.

The possible event types that map to A5are: Theft/Fraud (external); Theft/Fraud (internal); Unauthorized Trading; Information Security; Diversity/Discrimination; Terrorism/Political; Malicious Damage; Improper Business Practices (by firm); Sponsorship & Selection; Regulatory Monitoring/Reporting; Transaction Processing; Client Account Error; and System Failure.

Again, the only surviving event type in common with all five lists is Transaction Processing. And, because Transaction Processing exists in all five lists, the null set answer is avoided.

### Example 2

A terminated employee filed suit, claiming she was guaranteed a salary and bonus during the year. But in fact she was dismissed in a merger-related downsizing and offered a smaller severance package. A1: Employee (Internal); A2: Benefit to Firm; A3: Employee; A4: Financial (indirect, to client/3rd Party) Task; A5: Employer—Event Type: Employee Relations.

### Example 3

A retail employee used the bank's “house account” system to open a checking account. He diverted two incoming wire transfers into the account, quickly moving the proceeds to an offshore repository. He then boarded a plane and left the country. The employee's present whereabouts are unknown. A1: Employee (Internal); A2: Personal Benefit; A3: Firm/Shareholders; A4: Financial (direct); A5: Employee Conducting Internal, Non-Fiduciary Task—Event Type: Theft/Fraud (Internal).

### Example 4

A squirrel strayed into the main power grid for the northeastern United States, electrocuting itself and causing a six-hour power blackout. Money was lost when several partially executed trades were later completed at different market prices. A1: External Force (natural); A2: No Benefit Intended/Mistake; A3: Firm/Shareholders; A4: Trading/Markets Impact; A5: No Role or Responsibility—Event Type: Natural Disaster.

### Example 5

Holdings in a private banking client's managed investment account exceeded the agreed-upon limit for high-yield paper. Client account losses were reimbursed. A1: Employee (Internal); A2: Benefit to Firm; A3: Client; A4: Financial (indirect, to 3rd party); A5: Inv. Manager/Fiduciary/etc.—Event Type: Disclosure, Suitability & Fiduciary.

### Example 6

A computer hacker gained access to the bank's credit card records and obtained enough information to commit “identity theft” on several clients. Recognizing its failure to effectively prevent access, the bank absorbed the resulting losses. A1: Hacker; A2: Personal Benefit; A3: Client; A4: Financial (indirect, to 3rd party); A5: Not Sure—Event Type: Info/Systems Security.

### Example 7

A trader sold securities owned by the bank at a price that was $500,000 below market value, to a company in which she had a personal interest. The company immediately re-sold the securities at fair value and made $500,000. A1: Employee (Internal); A2: Personal Benefit; A3: Firm/Shareholders; A4: Trading/Market Impact; A5: Employee Conducting Internal, Non-Fiduciary Task—Event Type: Unauthorized Trading.

### Example 8

The bank faces NASD fines for taking excessive commissions from big investors for IPO shares. A1: Employee (Internal); A2: Benefit to Firm; A3: Client; A4: Financial (indirect, to 3rd party); A5: Ordinary Contractual/Commercial Counter party—Event Type: Improper Business Practices (by firm).

### Example 9

Banking regulators impose a fine for failure to detect and prevent a series of money laundering transactions. No member of the bank profited personally from the illegal activity. A1: Employee (Internal); A2: No Benefit Intended/Mistake; A3: Regulatory/Public or Governmental Interest; A4: Fine/Penalty; A5: Employee Conducting Internal, Non-Fiduciary Task—Event Type: Regulatory, Monitoring & Reporting

### Example 10

The bank sues a competitor for utilizing trade secrets provided it by an employee who the information with him when he left the firm. A1: Employee (External); A2: Benefit to Another Firm; A3: Firm/Shareholders; A4: Intellectual Property Loss; A5: Ordinary Contractual/Commercial Counter party—Event Type: Improper Business Practices (firm as victim) Or, one could also look at this as employee theft.

### Example 11

In 2001, employees of an armored car service that filled ATM machines for multiple banks in the southwest region of the U.S., diverted $203,000 for their own use. A1: Employee (External); A2: Personal Benefit; A3: Firm/Shareholders; A4: Financial (direct); A5: Employee Conducting Internal, Non-Fiduciary Task—Event Type: Theft/Fraud (external).

### Example 12

A brokerage firm pays $6M to settle claims regarding allegations that real estate limited partnership offering materials omitted to state material facts. A1: Employee (Internal); A2: Benefit to the Firm; A3: Client; A4: Financial (indirect, to 3rd party); A5: Under Duty to Disclose/Offer Suitable Deals—Event Type: Disclosure, Suitability & Fiduciary.

### Example 13

A regional US bank agrees to pay a civil penalty to the State of California for not dealing properly with the testing wastes created by the bank's environmental consultant at a borrower's property A1: Employee (Internal) [inc. Agents]; A2: No Benefit Intended/Mistake; A3: Regulatory/Public or Governmental Interest; A4: Fine/Penalty; A5: Not Sure/Not Applicable—Event Type: Regulatory, Monitoring & Reporting.

### Example 14

A court finds that a financial institution created a “hostile environment” that led to sexual discrimination against the plaintiff, by making sexist comments, inviting “escort girls” to a firm Christmas party, referring to female employees as “hot totty,” etc. A1: Employee (Internal); A2: Non-Financial Personal Benefit/Motive; A3: Employee; A4: Human, Personal, Privacy Rights; A5: Member of General Public/Ordinary Citizen—Event Type: Diversity/Discrimination.

1. A method of doing business subject to a risk event comprising the steps of:
providing questions to solicit answers that define attributes of the risk event;
obtaining the answers to the questions;
inputting the answers into a computer programmed to: 1) store the answers in the form of the attributes of the risk event, 2) map each answer to a list of possible event types corresponding to each answer, thereby generating a mapped list for each answer, and 3) compare the mapped lists to determine an event type of the risk event; and
taking action based on the determined event type.

2. The method of claim 1 wherein the computer is programmed to provide a user interface for providing the questions to an event reporter, and for receiving the answers to the questions from the event reporter, wherein each of the questions have only one answer that can be selected from a list of answers for the question, and wherein the selected answer becomes an attribute assigned to the risk event being reported.

3. The method of claim 1 wherein the computer is programmed to store the answers in the form of attributes of the event including, who or what initiated the event, what was the benefit to the initiator, who or what was impacted by the event, the nature of the impact, and the initiator's role in the event.

4. The method of claim 1 wherein the taking action comprises taking action based on a statistical analysis of past typed events, including the risk event.

5. The method of claim 1 wherein the taking action comprises taking preventive steps to reduce events of the event type.

6. The method of claim 1 wherein the step of providing questions further comprises providing a question regarding who or what initiated the event.

7. The method of claim 1 wherein the step of providing questions further comprises providing a question regarding what was the benefit to the initiator.

8. The method of claim 1 wherein the step of providing questions further comprises providing a question regarding who or what was impacted.

9. The method of claim 1 wherein the step of providing questions further comprises providing a question regarding the nature of the impact of the event.

10. The method of claim 1 wherein the step of providing questions further comprises providing a question regarding the initiator's role and level of responsibility and legal duty in the event.

11. The method of claim 1 wherein the computer is programmed to map each answer to a list of possible event types that include one or more of the following event types: theft/fraud, unauthorized trading, information security, personal safety, employee relations, diversity/discrimination, natural disaster, terrorism/political, malicious damage, disclosure suitability & fiduciary, improper business practices, tax violation, advisory actions, sponsorship & selection, regulatory monitoring/reporting, transaction processing, client account error, system failure, vendor dispute, and event type “unknown”.

12. The method of claim 1 wherein the risk event comprises one of the events selected from the group consisting of third party theft, employee theft, third party fraud, employee fraud, natural disaster, physical injury, illegal action by and employee, illegal action by the organization, and failure to take a required action.

13. A computer-assisted method of categorizing a risk event comprising the steps of:
providing questions to solicit answers that define attributes of the risk event;
obtaining the answers to the questions;
inputting the answers into a computer programmed to: 1) store the answers in the form of the attributes of the risk event, 2) map each answer to a list of possible event types, thereby generating a mapped list for each answer, and 3) compare all of the mapped lists to determine an event type of the risk event; and
displaying the event type.

14. A system for typing risk events comprising:
a computer programmed for event typing;
a user interface for posing questions regarding an event to an event reporter, and for receiving responses to the questions from the event reporter, each of the questions having only one answer that can be selected from a list of answers for the question, wherein the selected answer becomes an attribute assigned to the event being reported;
a look up table to generate a list of mapped possible event types for each answer;
wherein the programmed computer selects one or more event types common to the lists of mapped possible event types, and a user of the system takes an action based on the event type presented by the system.

15. The system of claim 14 further comprising a non-volatile memory.

16. The system of claim 15 wherein the memory records the attributes associated with the event.

17. The system of claim 15 wherein the memory records events, attributes and statistics regarding recorded event types.

18. The system of claim 14 wherein the questions comprise one or more questions regarding the event selected from the group of questions consisting of: who initiated the event, what was the benefit to the initiator, who was impacted, what was the damage to the impacted party, and what was the initiator's role/responsibility regarding the impacted party.

19. The system of claim 14 wherein the possible event types for each answer comprise one or more event types selected from the group of event types consisting of: theft/fraud, unauthorized trading, information security, personal safety, employee relations, diversity/discrimination, natural disaster, terrorism/political, malicious damage, disclosure suitability & fiduciary, improper business practices, tax violation, advisory actions, sponsorship & selection, regulatory monitoring/reporting, transaction processing, client account error, system failure, vendor dispute, and event type “unknown”.
